(19) United States
(12) Patent Application Publication
(10) Pub. No.: US 2013/0215269 A1
(43) Pub. Date: Aug. 22, 2013

(54) BIRD VIEW SYSTEM AND COMPENSATING METHOD THEREOF

(71) Applicants: YI-LIN HSIEH, Taichung City (TW); CHE-HUNG LIN, Nantou County (TW); CHUNG-FANG CHIEN, Taipei City (TW)

(72) Inventors: YI-LIN HSIEH, Taichung City (TW); CHE-HUNG LIN, Nantou County (TW); CHUNG-FANG CHIEN, Taipei City (TW)

(21) Appl. No.: 13/442,389

(22) Filed: Apr. 9, 2012

(30) Foreign Application Priority Data
Feb. 22, 2012 (TW) 101105919

(51) Int. Cl. H04N 7/18

(52) U.S. Cl. 348/148; 348/E07.085

(57) ABSTRACT

The present invention discloses a bird view system and a compensating method thereof. The system comprises a processing module and an image compensating module. The processing module receives and processes a bird view image generated from concatenating each image captured by each camera in the bird view system. The image compensating module compensates the bird view image. The processing module calculates a first compensation value and a second compensation value according to the difference of image information of overlapping or concatenating regions between an image and its adjacent right-hand or left-hand side images. The compensating module compensates the bird view image according to the first compensation value, the second compensation value and a compensation condition.

### CROSS-REFERENCE TO RELATED APPLICATION

This application claims the benefit of Taiwan Patent Application No. 101105919, filed on Feb. 22, 2012, in the Taiwan Intellectual Property Office, the disclosure of which is incorporated herein in its entirety by reference.

### BACKGROUND OF THE INVENTION

1. Field of the Invention

The present invention relates to an image compensating method and a system thereof, and more particularly to a bird view system and a compensating method there of capable of improving the consistence of image information at a joint boundary of a bird view image.

2. Description of Related Art

In present existing designs for vehicle safety, image capturing modules installed to a mobile vehicle for capturing surrounding images provides a dynamic panoramic bird view to assist a driving system has become a key research and development subject for major car and mobile vehicle system manufacturers. With the conversion and adjustment of images, environmental images captured by the general image capturing module are used for a bird view conversion, and the images are combined to form a panoramic bird view image. The panoramic bird view image not only provides a driving direction for a driver's reference, but also improves the safety of driving a car.

However, although the conventional panoramic bird view assisted driving technology comes with image capturing modules installed at different directions of the mobile vehicle to capture images, yet the direction of incident lights received by the car in a driving environment may vary, such that image information, such as brightness or color of an image captured by each image capturing module, cannot be consistent. Therefore, image information of adjacent regions in a composed panoramic bird view image will produce a color difference or inconsistent brightness produced by different light sources sensed by the image capturing module, and drivers are always confused with the observed image, and the driving assisting effect is lowered.

### SUMMARY OF THE INVENTION

In view of the aforementioned problems of the prior art, it is a primary objective of the invention to design a bird view system and a compensating method thereof to improve the deficiency of the conventional panoramic bird view system and overcome the inconsistence of the image information in a bird view image and causing a driver to be unable to determine the current driving conditions quickly and accurately, so that the invention can improve the convenience for drivers in a driving environment, so as to enhance the driving safety.

To achieve the foregoing objective, the present invention provides a bird view system, comprising: a processing module and an image compensating module. The processing module receives and processes each image captured by each camera of the bird view system to combine the images to form a bird view image. The image compensating module compensates the bird view image. Wherein, the processing module calculates a first compensation value according to a difference of image information of a concatenating region or an overlapping region between each image and its adjacent left-hand side or right-hand side image, and calculates a second compensation value according to another difference of image information of a concatenating region or an overlapping region between each image and an adjacent image on the other side of each image, and the image compensating module compensates the bird view image according to the first compensation value and the second compensation value and a compensation condition.

Preferably, the image information includes a color, brightness/darkness information, a YUV value, a RGB value, a Lab value, a YCbCr value, a YPbPr value and a Luv value.

Preferably, the compensation condition is established according to a positive value or a negative value of the first compensation value and the second compensation value, and if both of the first compensation value and the second compensation value are positive values or negative values, the image compensating module compensates the bird view image.

Preferably, if the first compensation value and the second compensation value of the compensation condition are not both positive values or negative values, the image compensating module selects the first compensation value or the second compensation value to compensate the bird view image first, and then the processing module reduces or expands a concatenating region or an overlapping region of each image, and re-calculates the first compensation value and the second compensation value, so that the image compensating module compensates the bird view image again according to a re-calculated first compensation value and a re-calculated second compensation value and the compensation condition.

Preferably, the image compensating module selects a smaller one from the first compensation value and the second compensation value, or an average of the first compensation value and the second compensation value as a compensation parameter, and the compensation parameter is used to compensate the bird view image.

Preferably, the image compensating module uses the compensation parameter calculated previously according to the bird view image captured by the bird view system to compensate the bird view image that is captured this time.

To achieve the foregoing objective, the present invention provides a bird view system, comprising: a processing module and an image compensating module. The processing module receives and processes each image captured by each camera of the bird view system to combine each image to form a bird view image, and calculates a first compensation value according to a difference of image information of a concatenating region or overlapping region between each image and its adjacent left-hand side or right-hand side image, and calculates a second compensation value according to another difference of image information of a concatenating region or overlapping region between the image and an adjacent image on the other side of the image. The image compensating means compensates the bird view image according to the first compensation value and the second compensation value and a compensation condition.

To achieve the foregoing objective, the present invention provides a bird view image compensating method comprising a processing means, receiving and processing each image captured by each camera of the bird view system to combine each image to form a bird view image, and calculating a first compensation value according to a difference of image information of a concatenating region or overlapping region between each image and its adjacent image on a left-hand side or a right-hand side, and calculating a second compensation value according to another difference of image information of a concatenating region or overlapping region between the image and an adjacent image on the other side of the image; and an image compensating means, compensating the bird view image for according to the first compensation value and the second compensation value and a compensation condition.

In summation, the bird view system and the compensating method of the invention capable of improving the consistency of image information at a joint boundary of a bird view image have the following advantage.

The bird view system and the compensating method of the invention can combine each image to form a bird view image with consistent colors, so that the application of the invention provides a better visual effect to drivers, reduces burden of the drivers' vision, so that the drivers can have a clearer view of the driving environment and conditions to improve the safety of driving.

### BRIEF DESCRIPTION OF THE DRAWINGS

FIG. 1 is a block diagram of a bird view system in accordance with a first preferred embodiment of the present invention;

FIG. 2 is a flow chart of a bird view system in accordance with the first preferred embodiment of the present invention;

FIG. 3 is a flow chart of a compensation condition of a bird view system in accordance with the first preferred embodiment of the present invention;

FIG. 4 is a block diagram of a bird view system in accordance with a second preferred embodiment of the present invention;

FIG. 5 is a flow chart of a bird view system in accordance with the second preferred embodiment of the present invention;

FIG. 6 is a flow chart of a bird view system in accordance with a third preferred embodiment of the present invention; and

FIG. 7 is a flow chart of a bird view system in accordance with the third preferred embodiment of the present invention.

### DETAILED DESCRIPTION OF THE PREFERRED EMBODIMENTS

The technical contents and characteristics of the image capturing device and its image processing method in accordance with the present invention will be apparent with the detailed description of a preferred embodiment accompanied with related drawings as follows. For simplicity, same numerals are used in the following preferred embodiment to represent respective same elements.

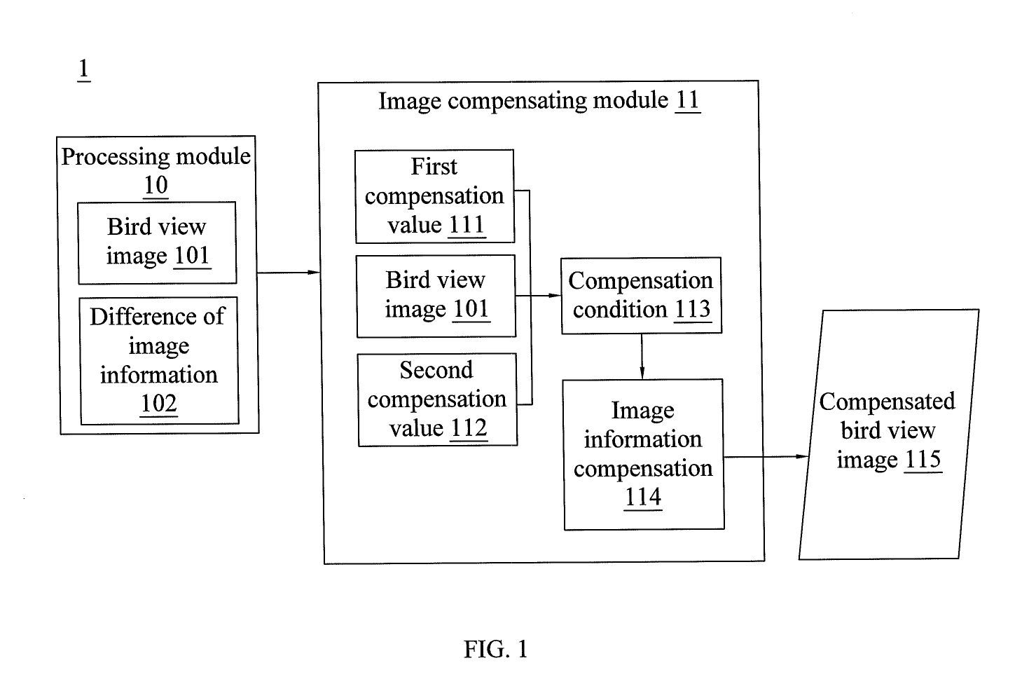

With reference to FIG. 1 for block diagram of a bird view system in accordance with the first preferred embodiment of the present invention, the bird view system 1 comprises a processing module 10 and an image compensating module 11. The processing module 10 can receive and process each image captured by each camera of the bird view system 1 and combine each image to form a bird view image 101, and generate a first compensation value 111 and a second compensation value 112 according to a difference of image information 102 of a concatenating region or an overlapping region between each image and an adjacent image on a right-hand side or a left-hand side.

The image compensating module 11 determines a compensation condition 113 of a bird view image 101 received by and transmitted from the processing module 10 according to a first compensation value 111 and a second compensation value 112 generated by each difference of image information 102 to perform an image information compensation 114 of the bird view image 101, so as to obtained a compensated bird view image 115.

In addition, the method of calculating each difference of image information 102 uses the processing module 10 to capture a plurality of image information of a concatenating region or overlapping region between each image and an adjacent image on the right-hand side or a left-hand side and calculate the difference by using an average of the plurality of adjacent image information to generate a first compensation value 111 and a second compensation value 112. Wherein, the image information includes but not limited to a color, brightness information, a YUV value, a RGB value, a Lab value, YCbCr value, a YPbPr value or a Luv value.

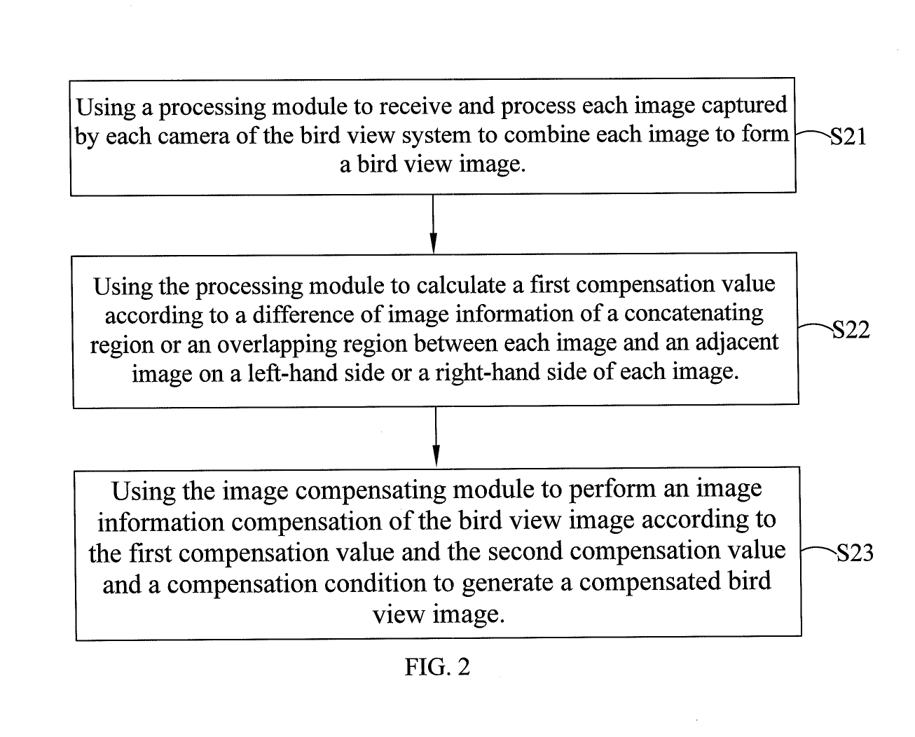

With reference to FIG. 2 for a flow chart of a bird view system in accordance with the first preferred embodiment of the present invention, the operating procedure of the bird view system comprises the following steps:

S21: Using a processing module to receive and process each image captured by each camera of the bird view system to combine each image to form a bird view image.

S22: Using the processing module to calculate a first compensation value according to a difference of image information of a concatenating region or an overlapping region between each image and an adjacent image on a left-hand side or a right-hand side of each image.

S23: Using the image compensating module to perform an image information compensation of the bird view image according to the first compensation value and the second compensation value and a compensation condition to generate a compensated bird view image.

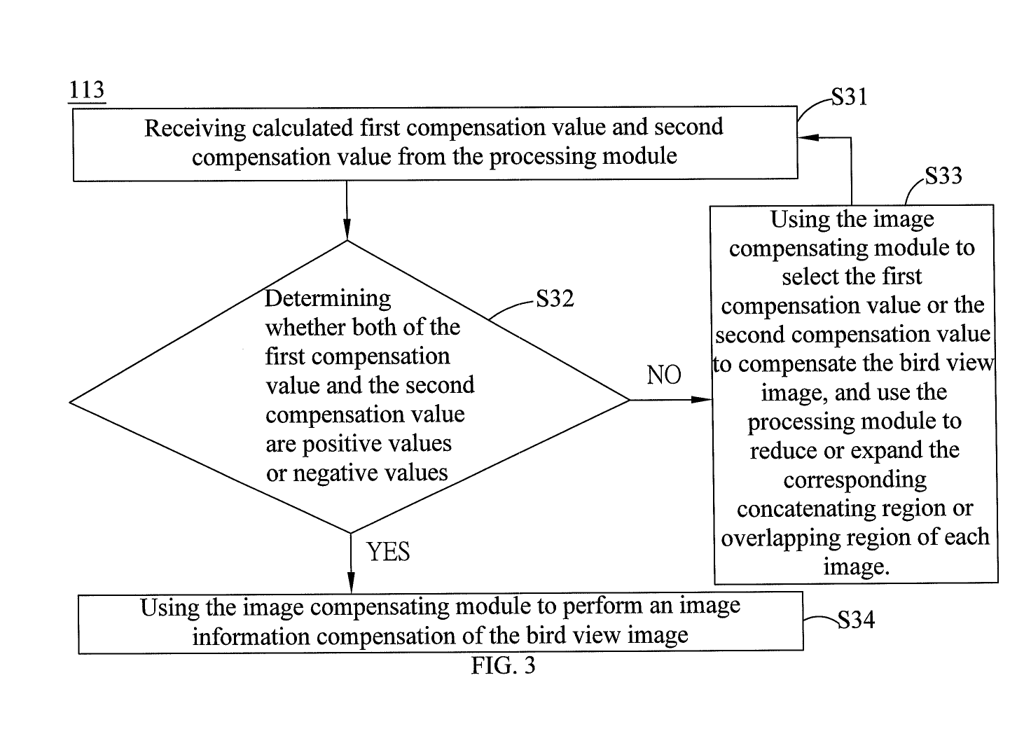

With reference to FIG. 3 for a flow chart of a compensation condition of a bird view system for improving the consistency of image information at the joint boundary of the bird view image in accordance with the first preferred embodiment of the present invention, the operating procedure comprises the following steps:

S31: Receiving calculated first compensation value and second compensation value from the processing module.

S32: Determining whether both of the first compensation value and the second compensation value are positive values or negative values.

S33: Using the image compensating module to select the first compensation value or the second compensation value to compensate the bird view image, and use the processing module to reduce or expand the corresponding concatenating region or overlapping region of each image.

S34: Using the image compensating module to perform an image information compensation of the bird view image.

Preferably, if the first compensation value and the second compensation value are determined to be both positive values or negative values, then the image compensating module will select a smaller one from the first compensation value and the second compensation value or an average of the first compensation value and the second compensation value as a compensation parameter to perform an image information compensation of the bird view image.

In addition, if the first compensation value and the second compensation value are determined to be not both positive values or negative values, the image compensating module will select the first compensation value or the second compensation value to compensate the bird view image, and further reduce the difference of each image information of the corresponding concatenating region or overlapping region of each image. The processing module further reduces or expands the concatenating region or overlapping region of each image according to a user's default condition to select the concatenating region or the overlapping region of each image more accurately. The processing module re-calculates the first compensation value and second compensation value according to the reduced or expanded concatenating region or overlapping region, so that the image compensating module can compensate the bird view image again according to the re-calculated first compensation value and second compensation value and a compensation condition.

It is noteworthy to point out that if the difference between the first compensation value and the second compensation value is smaller than a predetermined value, then the first compensation value and the second compensation value are considered to be equal to one another, and there is no need to perform the image information compensation of the bird view image.

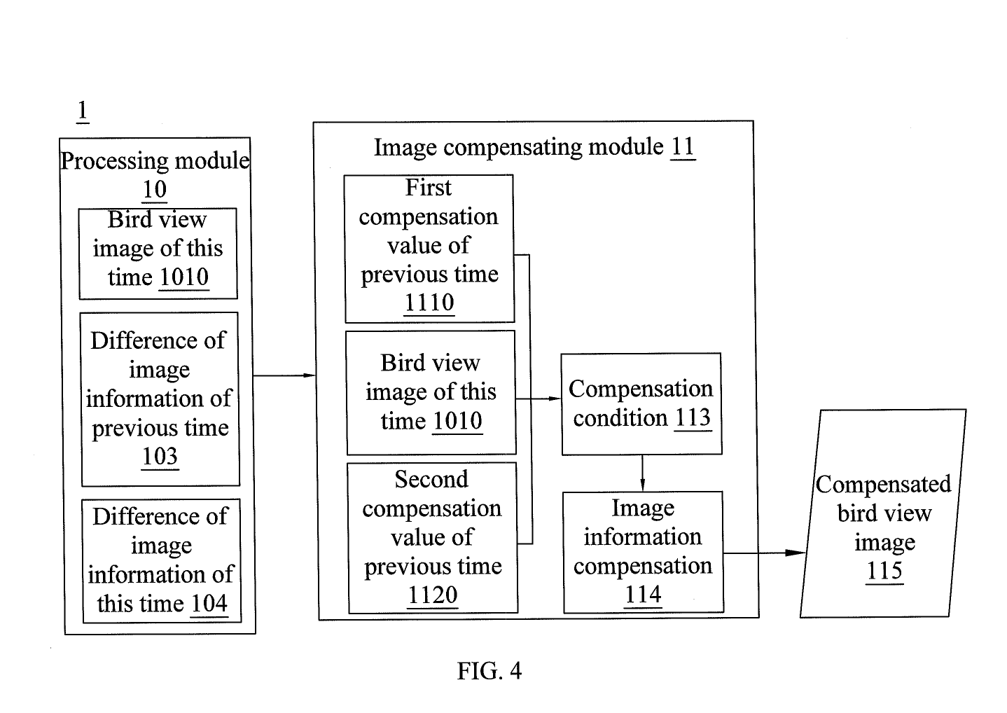

With reference to FIG. 4 for the block diagram of a bird view system in accordance with the second preferred embodiment of the present invention, the bird view system 1 comprises a processing module 10 and an image compensating module 11. The processing module 10 receives and processes each image captured by each camera of the bird view system 1 and combines the images to form a bird view image 101, and according to difference of image information 103 of a concatenating region or overlapping region between the previous image and its adjacent image on the right-hand side or the left-hand side to generate a first compensation value 1110 of the previous image and a second compensation value 1120 of the previous image.

The image compensating module 11 determines a compensation condition 113 of the bird view image 1010 of this time transmitted from the processing module 10 according to a first compensation value 1110 of the previous image and a second compensation value 1120 of the previous image generated by a difference of image information 103 of previous time to perform an image information compensation 114 of the bird view image 1010 of this time, so as to obtain a compensated bird view image 115.

It is noteworthy to point out that if each image is captured by each camera of the bird view system 1 and combined to form a bird view image to be transmitted to the processing module 10 next time, the image compensating module 11 will determine a compensation condition 113 of a bird view image of the next time transmitted from the processing module 10 according to a first compensation value of an image of this time and a second compensation value of an image of this time generated by the difference of image information 104 of an image of this time, so as to perform an image information compensation 114 for the bird view image of next time. Similarly, the same image information compensation 114 is performed for the bird view image of the next time.

In other words, the first compensation value 1110 of the previous image and the second compensation value 1120 of the previous image generated by the difference of the image information of the previous time are used to perform the image information compensation 114 for the bird view image 1010 of this time to achieve the effects of computing the compensation value of the bird view image and compensating the image information at the same time, so as to reduce the computing burden of the bird view system of the present invention. The invention not only saves computing resources and time, but also improves the efficiency of computing the image information compensation.

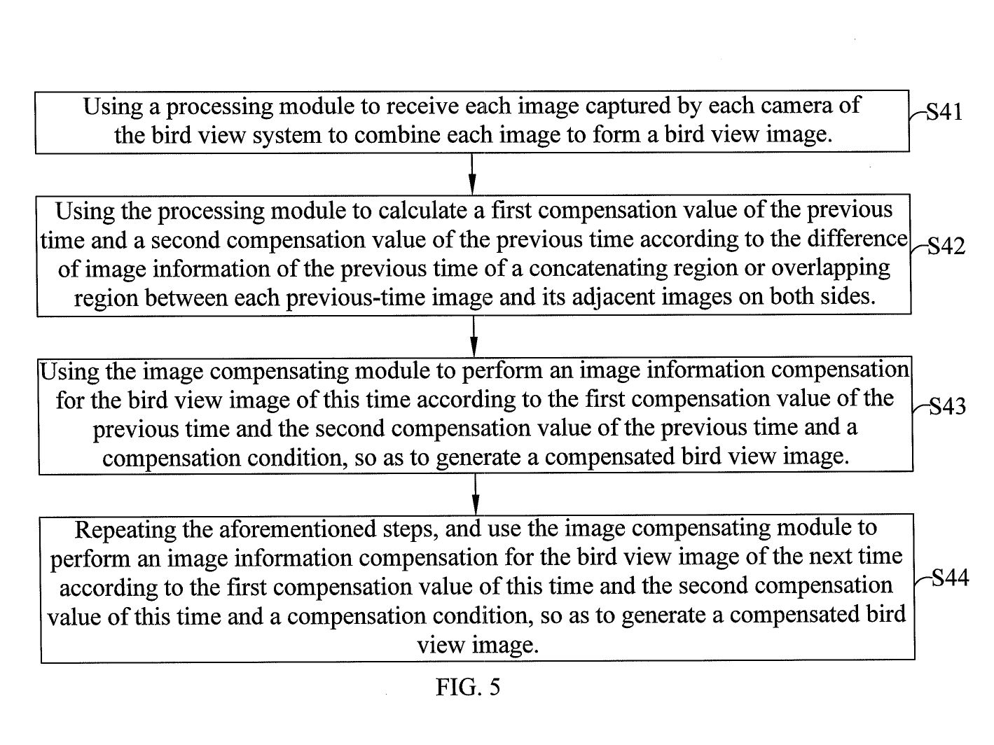

With reference to FIG. 5 for a flow chart of a bird view system in accordance with the second preferred embodiment of the present invention, the operating procedure of the bird view system comprises the following steps:

S41: Using a processing module to receive each image captured by each camera of the bird view system to combine each image to form a bird view image.

S42: Use the processing module to calculate a first compensation value of the previous time and a second compensation value of the previous time according to the difference of image information of the previous time of a concatenating region or overlapping region between each previous-time image and its adjacent images on both sides.

S43: Using the image compensating module to perform an image information compensation for the bird view image of this time according to the first compensation value of the previous time and the second compensation value of the previous time and a compensation condition, so as to generate a compensated bird view image.

S44: Repeating the aforementioned steps, and use the image compensating module to perform an image information compensation for the bird view image of the next time according to first compensation value of this time and the second compensation value of this time and a compensation condition, so as to generate a compensated bird view image.

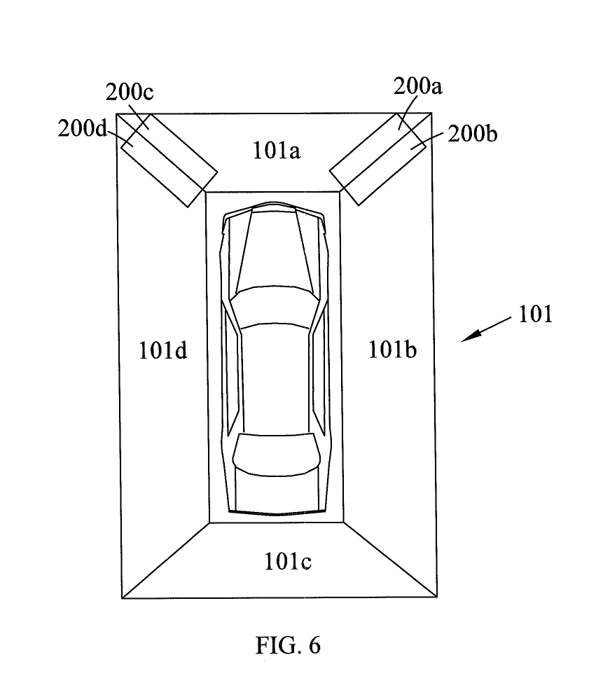

With reference to FIG. 6 for a schematic view of a bird view system in accordance with the third referred embodiment of the present invention, when the bird view system of the present invention is turned on, the processing module receives and processes each image 101a, 101b, 101c and 101d captured by each camera of the bird view system and combines the images to form a bird view image 101. A first compensation value and a second compensation value are generated according to a difference of image information of a concatenating region between each image and its adjacent images on the right-hand side and the left-hand side, and concatenating regions 200a, 200b and 200c, 200d between adjacent right-hand side and left-hand side images of an image 101a are used to obtain image information of concatenating regions respectively, and the image information of the right-hand side concatenating region 200a minus the image information of the right-hand side concatenating region 200b to obtain a first compensation value, and then the image information of the left-hand side concatenating region 200c minus the image information of the left-hand side concatenating region 200d to obtain a second compensation value. The remaining images 101b, 101c, 101d also use the aforementioned method to obtain the corresponding first compensation value and second compensation value, which can be combined to form each compensation parameter of the bird view image 101. And then, the image compensating module 11 according to each of the first compensation value and the second compensation value generated by subtracting the image information of each concatenating region to determine a compensation condition of the bird view image 101 transmitted from the processing module, so as to perform an image information compensation of the bird view image 101 to obtain a compensated bird view image.

Even though the bird view system of the present invention has described the concept of compensating images in accordance with the present invention, the following flow chart is provided for illustrating the invention in details.

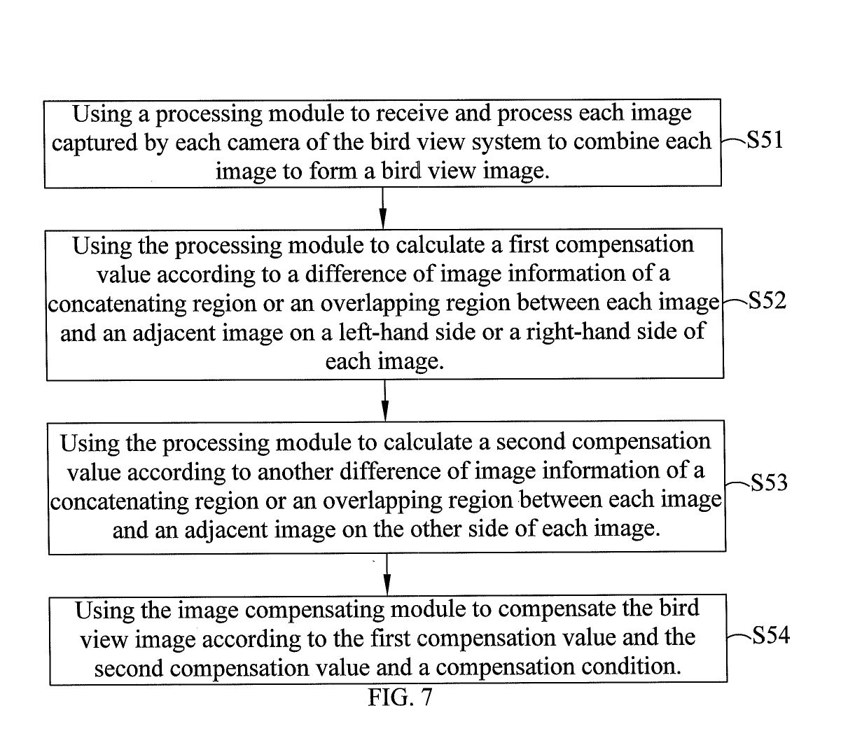

With reference to FIG. 7 for a flow chart of a bird view image compensating method bird view system in accordance with the present invention, the compensating method comprises the following steps:

S51: Using a processing module to receive and process each image captured by each camera of the bird view system to combine each image to form a bird view image.

S52: Using the processing module to calculate a first compensation value according to a difference of image information of a concatenating region or an overlapping region between each image and an adjacent image on a left-hand side or a right-hand side of each image

S53: Using the processing module to calculate a second compensation value according to another difference of image information of a concatenating region or an overlapping region between each image and an adjacent image on the other side of each image.

S54: Using the image compensating module to compensate the bird view image according to the first compensation value and the second compensation value and a compensation condition.

In summation of the description above, the bird view system and the compensating method in accordance with the present invention combine each image to form a bird view image with consistent colors, so that the application of the invention provides a better visual effect to drivers, reduces burden on the drivers' vision, so that the drivers can have a clearer view of the environment and conditions to improve the safety of driving. In a preferred embodiment, the bird view system and the compensating method of the present invention can use the compensated value of the bird view image calculated in previous time to compensate the bird view image directly this time, while calculating the compensation value of the bird view image for this time in order to compensate the bird view image for next time. This arrangement can reduce the memory requirement of the processing module significantly to achieve the effects of lowering the manufacturing cost, reducing the computing resources of the processing module, improving the efficiency and timely providing a compensated bird view image to users. Obviously, the present invention can overcome the drawbacks of the prior art.

What is claimed is:

1. A bird view system, comprising:
multiple cameras, capturing images;
a processing module, processing the images and combining the images to form a bird view image; and
an image compensating module, compensating the bird view image;
wherein the processing module calculates a first compensation value according to a difference of image information of a concatenating region or an overlapping region between each image of the images and an adjacent image on a left-hand side or a right-hand side of the each image, and calculates a second compensation value according to another difference of image information of a concatenating region or an overlapping region between the each image and an adjacent image on the other side of the each image, and the image compensating module compensates the bird view image according to the first compensation value, the second compensation value and a compensation condition.

2. The bird view system of claim 1, wherein the image information includes a color information, a brightness information, a YUV value, a RGB value, a Lab value, a YCbCr value, a YPbPr value or a Luv value.

3. The bird view system of claim 1, wherein the compensation condition is established according to a positive value or a negative value of the first compensation value and the second compensation value, and if both of the first compensation value and the second compensation value are positive values or negative values, the image compensating module compensates the bird view image.

4. The bird view system of claim 3, wherein if the first compensation value and the second compensation value of the compensation condition are not both positive values or negative values, the image compensating module selects the first compensation value or the second compensation value to compensate the bird view image first, and then the processing module reduces or expands a concatenating region or an overlapping region of each image, and re-calculates the first compensation value and the second compensation value, so that the image compensating module compensates the bird view image again according to a re-calculated first compensation value and a re-calculated second compensation value and the compensation condition.

5. The bird view system of claim 1, wherein the image compensating module selects a smaller one from the first compensation value and the second compensation value, or an average of the first compensation value and the second compensation value as a compensation parameter, and the compensation parameter is used to compensate the bird view image.

6. The bird view system of claim 5, wherein the image compensating module uses the compensation parameter calculated according to the bird view image previously formed to compensate a bird view image that is formed this time.

7. A bird view system, comprising:
multiple cameras, capturing images;
a processing means for processing the images and combining the images to form a bird view image, and calculating a first compensation value according to a difference of image information of a concatenating region or overlapping region between each image of the images and an adjacent image on a left-hand side or a right-hand side of the each image, and calculating a second compensation value according to another difference of image information of a concatenating region or overlapping region between the each image and an adjacent image on the other side of the each image; and
an image compensating means for compensating the bird view image for according to the first compensation value and the second compensation value and a compensation condition.

8. The bird view system of claim 7, wherein the image information includes a color information, a brightness information, a YUV value, a RGB value, a Lab value, a YCbCr value, a YPbPr value or a Luv value.

9. The bird view system of claim 7, wherein the compensation condition is established according to a positive value or a negative value of the first compensation value and the second compensation value, and if both of the first compensation value and the second compensation value are positive values or negative values, the image compensating module compensates the bird view image.

10. The bird view system of claim 9, wherein if the first compensation value and the second compensation value of the compensation condition are not both positive values or negative values, the image compensating module selects the first compensation value or the second compensation value to compensate the bird view image first, and then the processing module reduces or expands a concatenating region or an overlapping region of each image, and re-calculates the first compensation value and the second compensation value, so that the image compensating module compensates the bird view image again according to a re-calculated first compensation value and a recalculated second compensation value and the compensation condition.

11. The bird view system of claim 7, wherein the image compensating module selects a smaller one from the first compensation value and the second compensation value, or an average of the first compensation value and the second compensation value as a compensation parameter, and the compensation parameter is used to compensate the bird view image.

12. The bird view system of claim 11, wherein the image compensating module uses the compensation parameter calculated according to the bird view image previously formed to compensate a bird view image that is formed this time.

13. A bird view image compensating method, comprising the steps of:
using cameras for capturing images;
using a processing module to process images and combine the images to form a bird view image;
using the processing module to calculate a first compensation value according to a difference of image information of a concatenating region or an overlapping region between each image of the images and an adjacent image on a left-hand side or a right-hand side of the each image;
using a processing module to calculate a second compensation value according to another difference of image information of a concatenating region or an overlapping region between the each image and an adjacent image on the other side of the each image; and
using a image compensating module to compensate the bird view image according to the first compensation value, the second compensation value and a compensation condition.

14. The bird view image compensating method of claim 13, wherein the image information includes a color information, a brightness information, a YUV value, a RGB value, a Lab value, a YCbCr value, a YPbPr value or a Luv value.

15. The bird view image compensating method of claim 13, further comprising the step of: using the image compensating module to compensate the bird view image, if both of the first compensation value and the second compensation value are positive values or negative values.

16. The bird view image compensating method of claim 15, further comprising the steps of:
using the image compensating module to select the first compensation value or the second compensation value to compensate the bird view image, if the first compensation value and the second compensation value are not both positive values or negative values;
using the processing module to reduce or expand a concatenating region or a overlapping region of each image;
re-calculating the first compensation value and the second compensation value; and
using the image compensating module to compensate the bird view image according to a re-calculated first compensation value and a re-calculated second compensation value and the compensation condition.

17. The bird view image compensating method of claim 13, further comprising the step of: using the image compensating module to select a smaller one from the first compensation value and the second compensation value, an average of the first compensation value and the second compensation value as a compensation parameter to compensate the bird view image.

18. The bird view image compensating method of claim 17, further comprising the step of:
using the image compensating module to compensate a bird view image that is formed this time by the compensation parameter calculated according to the bird view image previously formed.
